(19) United States
(12) Patent Application Publication
(10) Pub. No.: US 2025/0086508 A1
(43) Pub. Date: Mar. 13, 2025

(54) METHOD FOR WEIGHTING A DATASET FOR TRAINING A MACHINE LEARNING MODEL

(71) Applicant: ROBERT BOSCH GmbH, Stuttgart (DE)

(72) Inventors: Lennart Haas, Tübingen (DE); Jared Evans, Sunnyvale, CA (US); Krishnan Bharath Navalpakkam, Milpitas, CA (US); Yannik Mezger, Stuttgart (DE)

(21) Appl. No.: 18/827,241

(22) Filed: Sep. 6, 2024

(30) Foreign Application Priority Data
Sep. 12, 2023 (DE) 10 2023 124 546.5

(51) Int. Cl. G06N 20/00

(52) U.S. Cl. CPC G06N 20/00

(57) ABSTRACT

The invention relates to a method for weighting a dataset for training a machine learning model, comprising the following steps:
ascertaining (101) a position of each data point (1) of the dataset in a feature space (2) of a further machine learning model,
ascertaining (102) a respective proximity of the data points (1) to at least one surrounding data point (1′) in the feature space (2) of the further machine learning model based on the position of the data points (1) ascertained,
determining (103) a weighting value for each data point (1) based on the proximity to the at least one surrounding data point (1′) ascertained,
using (104) the determined weighting values of the data points (1) when training the machine learning model, wherein the weighting values determined are used for an extent of consideration of the respective data points (1) in the training.

The invention further relates to a computer program, a device, and a storage medium for this purpose.

The invention relates to a method for weighting a dataset for training a machine learning model. The invention further relates to a computer program, a device, and a storage medium for this purpose.

### PRIOR ART

In datasets for training machine learning models, there may often be a plurality of identical or very similar data points and/or an unbalanced distribution of data points in individual classes for training the machine learning models. In the prior art, for example, identical points are therefore removed or classes are balanced against each other by different weighting. As another measure, further data can be collected, or the architecture of the machine learning model can be modified, in order to balance the dataset and improve the performance of the machine learning model.

Within a class, however, it can often occur that the data are not evenly distributed with respect to distribution in a feature space of a machine learning model. This unequal weighting can lead to problems, even with non-annotated data. In particular, the imbalance within a class can limit the learning capability of the machine learning model.

### DESCRIPTION OF THE INVENTION

The object of the invention is a method having the features of claim 1, a computer program having the features of claim 8, a device having the features of claim 9, as well as a computer-readable storage medium having the features of claim 10. Further features and details of the invention follow from the dependent claims, the description, and the drawings. In this context, features and details which are described in connection with the method according to the invention are clearly also applicable in connection with the computer program according to the invention, the device according to the invention, as well as the computer-readable storage medium according to the invention, and respectively vice versa, so mutual reference is always made or may be made with respect to the individual aspects of the invention.

The object of the invention is in particular a method for weighting a dataset for training a machine learning model, comprising the following steps:
ascertaining a position of each data point of the dataset in a feature space of a further machine learning model,
ascertaining a respective proximity of the data points to at least one surrounding data point in the feature space of the further machine learning model based on the position of the data points ascertained,
determining a weighting value for each data point based on the proximity to the at least one surrounding data point ascertained,
using the determined weighting values of the data points when training the machine learning model, whereby the weighting values determined are used for an extent of consideration of the respective data points in the training.

The machine learning model is in particular trained for classification and/or object detection. A trained machine learning model can accordingly result from the training and be used for classification and/or object detection. The use, and thus the inference, can be provided in a vehicle, for example. The data points of the dataset can, e.g., be pixels of image data, or based thereupon, in order to thereby perform classification and/or object detection of the data points on the basis of the pixels. By means of weighting, the dataset can advantageously enable more balanced, and thus improved, training of the machine learning model. For example, a computational need for training the machine learning model can be reduced, and the prediction quality by the machine learning model can be improved as a result. The dataset can comprise sensor data resulting from a measurement by at least one sensor. The sensor data can in this case be in digital form and can, e.g., be obtained using an analog-to-digital conversion. A weighting (also referred to as a weighting value) expresses in particular the extent to which a respective data point is or should be taken into account by the machine learning model when training. A feature vector is in particular an n-dimensional vector of numerical values representing an object. For example, a feature vector representation of an image can be retrieved from the output of an intermediate or last layer of a machine learning model. The feature space is preferably a vector space comprising the feature vectors. By way of the feature vector, each data point can be assigned a position in the feature space. In other words, a feature space can describe a multidimensional coordinate system in which each coordinate axis corresponds to a feature. The further machine learning model can be a model which is more powerful than the model being trained and which is used to weight the data points. The further machine learning model can, e.g., be a foundation model or a bootstrapped model. A foundation model is in particular a neural network having a plurality of parameters. Foundation models are preferably pretrained on massive datasets and can then be adapted to new tasks via further training using a smaller, specific dataset, or they can even be used directly, without adaptation. In particular, a bootstrapped model has the same architecture as the model being trained, but it can be trained on the raw, unweighted dataset, or on another dataset. Imbalances can occur in large datasets in particular, and their effects on machine learning model training can advantageously be reduced using the weighting according to the present invention. In simple terms, the weighting value can be determined such that a lower weighting value is assigned to data points in proximity to each other, whereas data points which are relatively far away from further data points are assigned a higher weighting value.

It is also advantageous for the method to further comprise the following step:
extracting a feature vector based on the feature space by means of the further machine learning model in order to provide a reduced feature space via the feature vector.

In particular, a feature vector generally summarizes parametrizable properties of a pattern in a vectorial manner. Various features characteristic of the pattern can form the various dimensions of this vector. The feature space can be effectively reduced by means of various feature extraction methods. One example would be a feature selection in which the most relevant features are selected, and the less relevant or redundant features are ignored. As a result, the feature space can be reduced without changing the actual data. A further option would be a feature projection which creates new features that are combinations of the original features. These new features preferably retain important information, but in a more compact format. Techniques such as principal component analysis (PCA) or t-distributed stochastic neighbor embedding (t-SNE) are examples of feature projections.

The ascertainment of the position of each data point in the dataset can then be performed in the reduced feature space provided. By reducing the feature space, computational effort can be advantageously reduced when ascertaining the proximity of the data points to surrounding data points and determining weighting values for the data points.

Within the scope of the invention, it can also be provided that the determination of the weighting value be performed by taking at least one weighting condition into account in order to, by means of the at least one weighting condition, provide variability when determining the weighting value for each data point. Advantageously, the weighting can thereby be individually influenced and, e.g., adapted to various types of datasets.

It can optionally be provided that the at least one weighting condition be selected from the following:
assigning a respective half weighting value, in particular a weighting value of 0.5 in each case, to two respective identical data points,
assigning a full weighting value, in particular a weighting value of 1, to a respective data point if the proximity to the at least one surrounding data point is greater than a defined threshold value,
assigning a weighting value of 1/N to a respective data point if N identical data points are present.

In other words, at least one of the preceding weighting conditions can respectively be applied or taken into account when determining the weighting value. The weighting conditions can be supplemented by additional weighting conditions, depending on the requirements.

It is also optionally conceivable that the ascertainment of the proximity of the data points to the at least one surrounding data point further comprises the following steps:
defining a maximum distance,
searching for the at least one surrounding data point starting from a respective data point within the maximum distance.

Stated in simple terms and explained with reference to a circle, at least one further data point can be sought for each data point within a circle having a maximum radius that is the maximum distance. If at least one further data point is present in the circle, the weighting value of the data point can be determined based on a distance between the data point and the respective at least one further data point. By defining the maximum distance, computational effort can advantageously be reduced because at least one additional data point need not be sought for each data point in the entire feature space, and the distance for the weighting must be taken into account. The maximum distance can be established empirically.

It can also be provided that the training of the machine learning model is a supervised training and the dataset comprises at least two designated classes for the supervised training, and the method further comprises the following step:
equating a respective total weighting value of the at least two classes, whereby the respective total weighting value is determined by a number of data points of the respective class and a respective weighting of each data point.

The term “equating” is in particular used to express that the respective total weighting value of the at least two classes is set to the same value. For example, if class A has 100 points with a net weighting of 50 and class B has 200 points with a net weighting of 150, then tripling the weighting for class A can advantageously lead to better results. By adding weighting to the classes, the dataset can be further balanced, and the training of the machine learning model can be improved as a result.

It can also be advantageous for the dataset to comprise sensor and/or image data. The dataset can in this case comprise image data in order to train the machine learning model for a predefined task at the data points in the form of image data pixels. The sensor and/or image data can result from collection by at least one sensor and/or can be synthetic data that can replicate actual data from a sensor. In more general terms, the sensor data can be specific to collection by a sensor, i.e., directly resulting (for example) from real-world collection and/or which have been synthesized. The sensor can, e.g., be a radar sensor, an ultrasonic sensor, a LiDAR, a camera, or a thermal imaging camera. Accordingly, the sensor and/or image data can be or comprise video images, and/or radar images, and/or ultrasound images, and/or distance information, and/or thermal images.

The machine learning model can be trained using the dataset, preferably according to the predefined task, in order to detect and/or classify recognition features in the sensor and/or image data. The predefined task can be a classification task. The classification task comprises, e.g., object detection in the sensor and/or image data, and/or semantic segmentation. In addition, the predefined task can also comprise a downstream task such as at least partially automated driving. Accordingly, control of an at least partially automated vehicle can be provided on the basis of the classification and/or image classification. The detection features can be objects such as traffic signs, traffic lights, pedestrians, or comparable features.

The weighting values determined can advantageously be used to account for the feature space in a more uniform manner during training for the predefined task because underrepresented areas in the feature space in particular are weighted more strongly and are therefore also taken into account more strongly. As a result, the identifying features can be better detected and/or classified by the machine learning model.

The sensor data can optionally include the image data, which can result from collection by a camera sensor. Alternatively or additionally, the image data can comprise synthetic data. The values of pixels, preferably pixels, of the image data can in this case represent an environment and/or a traffic scene. Objects, e.g. the environment and/or the traffic scene, can optionally be detected by means of a classification (and preferably image classification) based on these values. The classification and/or image classification can in this case also be performed in the form of semantic segmentation (i.e., a pixel or area classification) and/or object detection. The image data can also be in the form of radar images and/or ultrasound images, and/or thermal images, and/or lidar images.

The at least one sensor can be arranged in the vehicle. It is therefore possible that the method according to the invention be used in the vehicle. The vehicle can, e.g., be designed as a motor vehicle, and/or passenger vehicle, and/or autonomous vehicle. The vehicle can comprise a vehicle arrangement for, e.g., providing an autonomous driving function and/or a driver assistance system. The vehicle arrangement can be designed to control the vehicle in an at least partially automated manner, and/or accelerate, and/or brake, and/or steer the vehicle.

Another aspect of the invention is a computer program, in particular a computer program product comprising commands that, when the computer program is executed by a computer, prompt the latter to perform the method according to the invention. The computer program according to the invention thereby provides the same advantages as described in detail with regard to a method according to the invention.

Another aspect of the invention is a device for data processing, which is configured to perform the method according to the invention. For example, a computer can be provided as the device which executes the computer program according to the invention. The computer can comprise at least one processor for executing the computer program. A non-volatile data storage means can also be provided, in which the computer program is stored and from which the computer program can be read by the processor for execution.

Another aspect of the invention is a computer-readable storage medium comprising the computer program according to the invention and/or comprising commands that, when executed by a computer, prompt the latter to perform the method according to the invention. The storage medium is, e.g., designed as a data storage means such as a hard disk, and/or a non-volatile memory, and/or a memory card. The storage medium can, e.g., be integrated into the computer.

The method according to the invention can furthermore be designed as a computer-implemented method.

Further advantages, features, and details of the invention follow from the description hereinafter, in which embodiments of the invention are described in detail with reference to the drawings. In this context, each of the features mentioned in the claims and in the description may be essential to the invention, whether on their own or in any combination. Shown are:

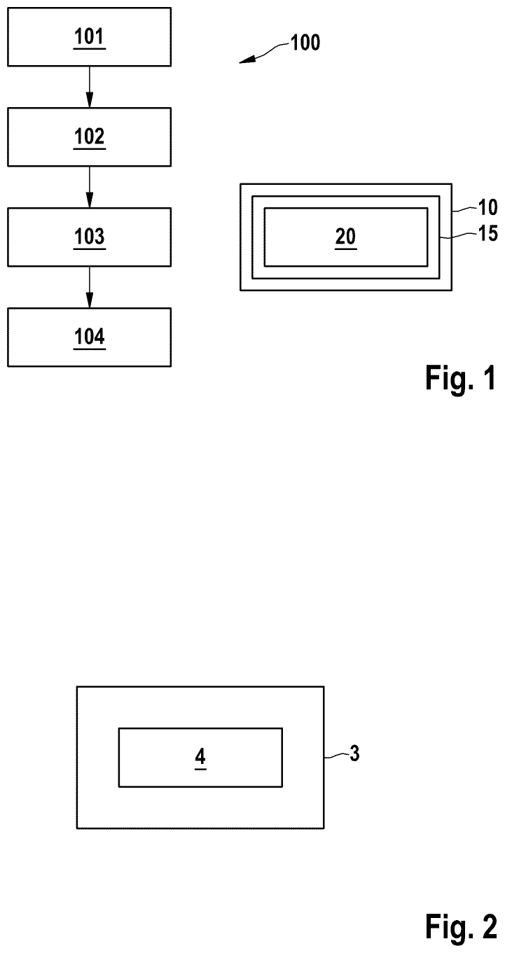

FIG. 1 a schematic illustration of a method, a device, a storage medium, as well as a computer program according to exemplary embodiments of the invention.

FIG. 2 a schematic representation of a vehicle and a sensor according to exemplary embodiments of the invention,

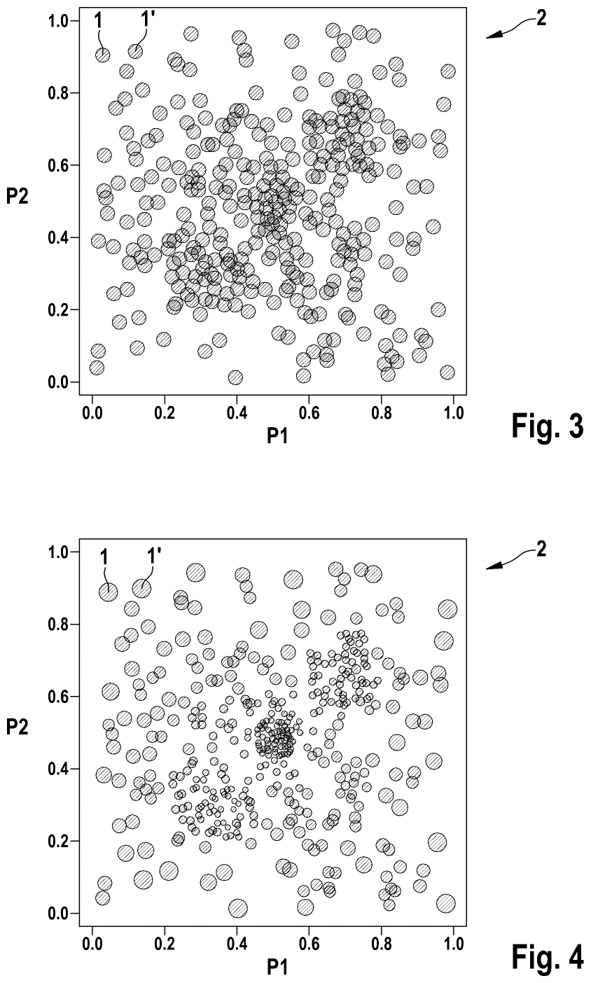

FIG. 3 a schematic representation of data points in a feature space without weighting,

FIG. 4 a schematic representation of data points in a feature space with weighting according to embodiments of the invention.

Schematically shown in FIG. 1 are a method 100, a device 10, a storage medium 15, as well as a computer program 20 according to exemplary embodiments of the invention.

FIG. 1 in particular shows a method 100 for weighting a dataset for training a machine learning model. In a first step 101, a position of each data point 1 of the dataset is preferably ascertained in a feature space 2 of a further machine learning model. In a second step 102, a respective proximity of the data points 1 to at least one surrounding data point 1′ in the feature space 2 of the further machine learning model can be ascertained based on the position of the data points ascertained. In a third step 103, a weighting value for each data point 1 can be determined based on the ascertained proximity to the at least one surrounding data point 1′. In a fourth step, the determined weighting values of the data points 1 can be used when training the machine learning model, whereby the weighting values determined are used for an extent of consideration of the respective data points 1 in the training.

FIG. 2 schematically shows a vehicle 3 comprising a sensor 4. The sensor 4 can collect sensor data in order to provide the dataset for training the machine learning model.

FIG. 3 shows a feature space 2 of two parameters P1 and P2, with a plurality of data points 1 further being shown in the feature space 2. The data points 1 in FIG. 2 are not weighted in this case, which is indicated by all of the data points 1 having the same size. Respective surrounding data points 1′ exist in addition to said data points.

FIG. 4 shows the same feature space 2 as in FIG. 3 for parameters P1 and P2, with a weighting of the data points 1 according to exemplary embodiments of the invention having been performed. Respective surrounding data points 1′ can be seen in addition to the data points, with the proximity of each of the data points 1 to the surrounding data points 1′ for the respective data point 1 having been taken into account for the weighting of the respective data point 1. The weighting is in this case indicated by different sizes for the data points 1.

In particular, the invention provides a method in which what is referred to as a diversity score assignment can be performed, for which purpose specific weighting values are preferably assigned to the data points 1. In particular, positions of the data points 1 in a feature space 2 are weighted differently in order to balance the training data by means of the weighting.

By reducing dataset imbalance, the invention can be applied in an advantageous manner to enable faster learning, better performance, and less distortion in machine learning models. In particular, energy consumption may be reduced by training the machine learning model more quickly.

The intraclass imbalance in particular hinders the ability of a machine learning model to learn the most from a dataset. Repeated contact with redundant information can facilitate the learning of a specific scenario, but it may also reduce the ability of the machine learning model to generalize with respect to less common samples. In particular, the present invention creates a diversity-based mechanism for reducing this redundant load during training. Methods for reducing dataset imbalance can lead to faster learning, better performance, and less distortion. Faster training may reduce energy consumption resulting from, e.g., GPU usage when training some of the largest machine learning models. The reduction in distortion can sometimes be difficult to measure, but it would in particular be valuable for basic models trained on huge, unannotated datasets (e.g., originating from the internet).

This invention can be an upstream portion of the machine learning tool chain. One aspect of this invention is in particular the use of diversity score assignment via data point positions in a feature space 2 in order to weight the training data. This weighting can then be either used as unweighted data (e.g., removal of data points by subsampling), weighted data (e.g., weighting values are used during training), or weighted sampling (e.g., fewer or more unique or weighted images are applied in an undersampled or oversampled manner during training).

In order to perform the weighting, the data can be weighted by initially including a feature vector from a further machine learning model, such as a base model (e.g., CLIP), a model trained under supervision (e.g., a ResNet trained on ImageNet), or a bootstrapped model (i.e., the target model architecture, but trained on the unweighted, raw dataset). The diversity assessment, or rather the weighting, then results from, e.g., the search for other nearby data points 1 in this (reduced) feature space 2 and the weighting thereof according to proximity.

In addition, the following conditions can, e.g., be expressed when constructing a weighting metric: If two data points 1 are identical, then they should each have half of a weighting value. If a data point 1 does not have similar points in the dataset, then it should have a weighting value of near one. If there are N very similar points, then they should be weighted at approximately 1/N. Points nearby one another, but not overlapping, should have a lower contribution, but not completely (i.e., the sum of these N points should be greater than 1).

One example of a metric that can generate this behavior is as follows:

$${W}_{i} = {( {\sum }_{j}^{n} {e}^{- \frac{{d}_{i j}}{{d}_{c}}} )}^{- 1}$$

where dᵢⱼ is preferably the distance between the feature vectors, wherein dᵢᵢ=0, and thus the resulting weighting value, results in 1. d_{c} is preferably an empirically determined distance, also referred to as a critical distance. Although this sum could in principle be formed over all objects, it may be more computationally practical to consider only contributions within a multiple of the critical distance, e.g. r_{c}=kd_{c} where k=5.

The value for the critical distance can be changed in order to achieve different goals. In particular, a smaller value results in reduced weighting of effectively identical images. Given a larger value, points that are more distant will preferably affect the weighting of a point. Although the weighting metric specified hereinabove satisfies the conditions (for example), many variations may exist which are able to be considered in various scenarios, e.g. changing the exponential value to a Gauss value or using d_{c}(xᵢ) for adaptive weighting. In addition, a kernel density approach could be followed instead of the preceding proximity approach.

In the case of supervised learning, performance can be improved if an additional class weighting is added after the weighting according to proximity.

The foregoing explanation of the embodiments describes the present invention only by way of examples. Insofar as technically advantageous, specific features of the embodiments may obviously be combined at will with one another without departing from the scope of the present invention.

1. A method for weighting a dataset for training a machine learning model, comprising the following steps:
ascertaining a position of each data point (1) of the dataset in a feature space (2) of a further machine learning model,
ascertaining a respective proximity of the data points (1) to at least one surrounding data point (1′) in the feature space (2) of the further machine learning model based on the position of the data points (1) ascertained,
determining a weighting value for each data point (1) based on the proximity to the at least one surrounding data point (1′) ascertained,
using the determined weighting values of the data points (1) when training the machine learning model, wherein the weighting values determined are used for an extent of consideration of the respective data points (1) in the training.

2. The method according to claim 1, characterized in that the method further comprises the following step:
extracting a feature vector based on the feature space (2) by means of the further machine learning model in order to provide a reduced feature space via the feature vector,
wherein the ascertainment of the position of each data point (1) of the dataset is performed in the reduced feature space provided.

3. The method according to claim 1, characterized in that the determination of the weighting value is performed by taking at least one weighting condition into account in order to provide variability in the determination of the weighting value for each data point (1) by means of the at least one weighting condition.

4. The method according to claim 3, characterized in that the at least one weighting condition is selected from:
assigning a respective half weighting value, in particular a weighting value of 0.5 in each case, to two respective identical data points (1),
assigning a full weighting value, in particular a weighting value of 1, to a respective data point (1) if the proximity to the at least one surrounding data point (1′) is greater than a defined threshold value, assigning a weighting value of 1/N to a respective data point (1) if N identical data points (1) are present.

5. The method according to claim 1,
characterized in that the ascertainment of the proximity of the data points (1) to the at least one surrounding data point (1′) further comprising the following steps:
defining a maximum distance,
searching for the at least one surrounding data point (1′) starting from a respective data point (1) within the maximum distance.

6. The method according to claim 1, characterized in that the training of the machine learning model is a supervised training and the dataset comprises at least two designated classes for the supervised training, and the method further comprises the following step:
equating a respective total weighting value of the at least two classes, wherein the respective total weighting value is determined by a number of data points (1) of the respective class and a respective weighting of each data point (1).

7. The method according to claim 1,
characterized in that
the dataset comprises image data used to train the machine learning model for a predefined task in the data points in the form of pixels of the image data, in particular to train the machine learning model by means of the dataset in order to classify recognition features in the image data, wherein, by means of the weighting values determined, the feature space (2) is taken into account more uniformly when training for the predefined task.

8. (canceled)

9. A device for data processing, which is configured to:
ascertain a position of each data point (1) of the dataset in a feature space (2) of a further machine learning model,
ascertain a respective proximity of the data points (1) to at least one surrounding data point (1′) in the feature space (2) of the further machine learning model based on the position of the data points (1) ascertained,
determine a weighting value for each data point (1) based on the proximity to the at least one surrounding data point (1′) ascertained,
use the determined weighting values of the data points (1) when training the machine learning model, wherein the weighting values determined are used for an extent of consideration of the respective data points (1) in the training.

10. A non-transitory computer-readable storage medium comprising commands that, when executed by a computer, causes the computer to:
ascertain a position of each data point (1) of the dataset in a feature space (2) of a further machine learning model,
ascertain a respective proximity of the data points (1) to at least one surrounding data point (1′) in the feature space (2) of the further machine learning model based on the position of the data points (1) ascertained,
determine a weighting value for each data point (1) based on the proximity to the at least one surrounding data point (1′) ascertained,
use the determined weighting values of the data points (1) when training the machine learning model, wherein the weighting values determined are used for an extent of consideration of the respective data points (1) in the training.
